(19) United States
(12) Patent Application Publication
(10) Pub. No.: US 2008/0062089 A1
(43) Pub. Date: Mar. 13, 2008

(54) ORGANIC ELECTRO LUMINESCENCE DISPLAY DEVICE AND DRIVING METHOD FOR THE SAME

(75) Inventors: Mi Hae KIM, Seoul (KR); Tae Gyu Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/688,365

(22) Filed: Mar. 20, 2007

(30) Foreign Application Priority Data
Sep. 13, 2006 (KR) 2006-0088641

(51) Int. Cl. G09G 3/30

(52) U.S. Cl. 345/76

(57) ABSTRACT

An organic electroluminescence display device capable of reducing a size of a data driver by reducing the channel number of the data driver, and capable of reducing a deviation of electric current flowing in pixels by resetting data lines, and a driving method for the same. The organic electroluminescence display device includes a pixel unit having a plurality of pixels defined by data lines and scan lines and displaying an image to correspond to a data signal and a scan signal; a data driver generating a data signal to supply the data signal to the pixel unit in every channel; a MUX unit to which the data lines are connected to correspond to one channel outputting the data signal from the data driver and selectively supplying the data signal, outputted from the channel according to the control signal, to one of the data lines; and a scan driver generating a scan signal to supply the generated scan signal to the pixel unit, wherein a reset signal transmitting unit supplying a reset signal is connected to the channel of the data driver to connect the reset signal to the data lines through the MUX unit.

### CROSS-REFERENCE TO RELATED APPLICATION

This application claims the benefit of Korean Patent Application No. 2006-88641, filed on Sep. 13, 2006, in the Korean Intellectual Property Office, the disclosure of which is incorporated herein by reference.

### BACKGROUND OF THE INVENTION

1. Field of the Invention

An aspect of the present invention relates to an organic electroluminescence display device and a driving method for the same, and more particularly to an organic electroluminescence display device capable of reducing a deviation of electric current flowing in pixels by resetting a data signal stored in data lines, and a driving method for the same.

2. Description of the Related Art

In recent years, there has been much development in the field of flat panel displays which are more lightweight and have a smaller volume than a cathode ray tube. Currently, flat panel displays include a display region in which a plurality of pixels are arranged in a matrix form on a substrate, and an image is displayed by connecting scan lines and data lines to each of the pixels to selectively apply a data signal to the pixels.

The flat panel displays are classified into a passive matrix type light emitting display and an active matrix type light emitting display, depending on the driving systems of the pixels. The active matrix type light emitting display which selectively turns on the light in every unit pixel has been widely used due to its superior resolution, contrast, and response time.

Flat panel displays are used as displays or monitors in apparatuses such as personal computers, mobile phones, PDA's, etc., and LCD's using a liquid crystal panel, an organic electroluminescence display device using an organic light emitting diode, PDP's using a plasma panel and the like have been widely known in the art. In particular, an organic electroluminescence display device which has excellent luminous efficiency, luminance and viewing angle and a rapid response time stands out.

FIG. 1 is a schematic view showing a conventional organic electroluminescence display device. Referring to FIG. 1, the organic electroluminescence display device includes a pixel unit 10, a data driver 20 and a scan driver 30.

The pixel unit 10 has a plurality of pixels 11 arranged therein, and organic light emitting elements (not shown) connected to each of the pixels 11. The pixel unit has a plurality of scan lines (S1,S2, . . . Sn−1,Sn) arranged in a horizontal direction for transmitting a scan signal, and a plurality of data lines (D1, D2, . . . Dm−1, Dm) arranged in a vertical direction for transmitting a data signal. The pixel unit 10 displays an image by allowing the luminous elements to emit the lights according to the scan signal and the data signal.

The data driver 20 is a unit for applying a data signal to the pixel unit 10, and is connected to the data lines (D1, D2, . . . Dm−1, Dm). In the data driver 20, a plurality of channels (not shown), to which the data signal is outputted, are connected to the data lines (D1, D2, . . . Dm−1, Dm), and one data line is connected to one channel.

The scan driver 30 is a unit sequentially outputting a scan signal and is connected to the scan lines (S1,S2, . . . Sn−1,Sn) in order to supply the scan signal to a specific row of the pixel unit 10. The data signal inputted in the data driver 20 is applied to a specific row of the pixel unit 10 to which the scan signal is supplied in order to display an image, and one frame is completed if all rows are sequentially selected.

In the organic electroluminescence display device as configured above, each of the pixels connected to the same scan line are connected to different data lines, and therefore wires are complicated as the number of the data lines connected to the pixel unit increase. Also, if the number of the data lines increases, then the channel number of the data drivers also increases and a size of the data driver is enlarged, therefore increasing the entire cost of the device.

Also, the previous data signals are stored in the data lines, and an image may deteriorate since a deviation occurs in an electric current flowing in the pixels.

### SUMMARY OF THE INVENTION

Accordingly, an aspect of the present invention is designed to solve such drawbacks of the related are art and/or other drawbacks, and therefore an aspect of the present invention is to provide an organic electroluminescence display device capable of reducing a size of a data driver by reducing the number of channels of the data driver, and also reducing a deviation of electric current flowing in pixels by resetting the data lines, and a driving method for the same.

An aspect of the present invention is achieved by providing an organic electroluminescence display device including a pixel unit including a plurality of pixels defined by data lines and scan lines and displaying an image corresponding to a data signal and a scan signal; a data driver generating a data signal to supply the data signal to the pixel unit in every channel; a MUX unit to which the three data lines are connected and which correspond to one channel, the MUX unit outputting the data signal from the data driver to one of the three data lines according to a control signal; and a scan driver generating a scan signal to supply the generated scan signal to the pixel unit, wherein a reset signal transmitting unit supplying a reset signal is connected to the channels of the data driver and resets the data lines through the MUX unit.

According to another aspect of the present invention there is provided an organic electroluminescence display device including a pixel unit including a plurality of pixels defined by data lines and scan lines and displaying an image to correspond to a data signal and a scan signal; a data driver generating a data signal to supply the data signal to the pixel unit in every channel; a MUX unit to which three data lines are connected corresponding to one channel, the MUX unit outputting the data signal from the data driver and selectively supplying the data signal, to one of the three data lines according to a control signal; a reset unit connected to the data line and supplying a ground power source; and a scan driver for generating a scan signal to supply the generated scan signal to the pixel unit.

Another aspect of the present invention is achieved by providing a method of driving an organic electroluminescence display device that resets data lines using a reset signal, the method including generating a data signal to supply the generated data signal to data lines; and interrupting the data signal and supplying the reset signal to the data lines of a pixel electrode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing a conventional organic electroluminescence display device.

FIG. 2 is a schematic view showing an organic electroluminescence display device according to an aspect of the present invention.

FIG. 3 is a schematic view showing an organic electroluminescence display device according to an aspect of the present invention.

FIG. 4 is a schematic view showing a data driver used in the organic electroluminescence display device as shown in FIG. 2.

FIG. 5 is a circuit view showing a connection relation between a data driver and a MUX unit in the organic electroluminescence display device shown in FIG. 2.

FIG. 6 is a circuit view showing a connection relation between a data driver and a MUX unit in the organic electroluminescence display device shown in FIG. 3.

FIG. 7 is a diagram showing a voltage of a data line in the organic electroluminescence display device shown in FIG. 2.

FIG. 8 is a diagram showing a voltage of a data line in the organic electroluminescence display device shown in FIG. 3.

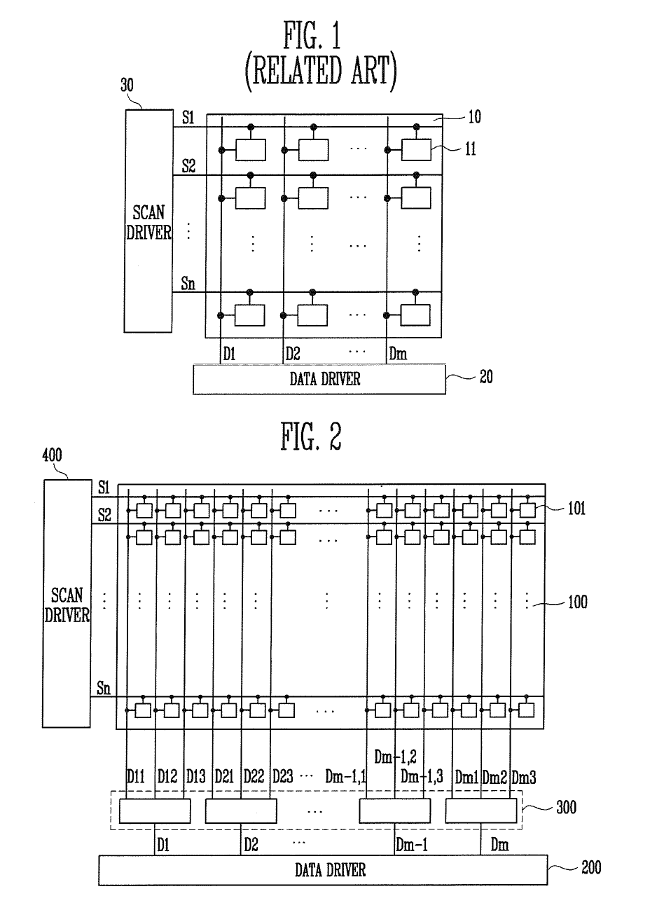

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

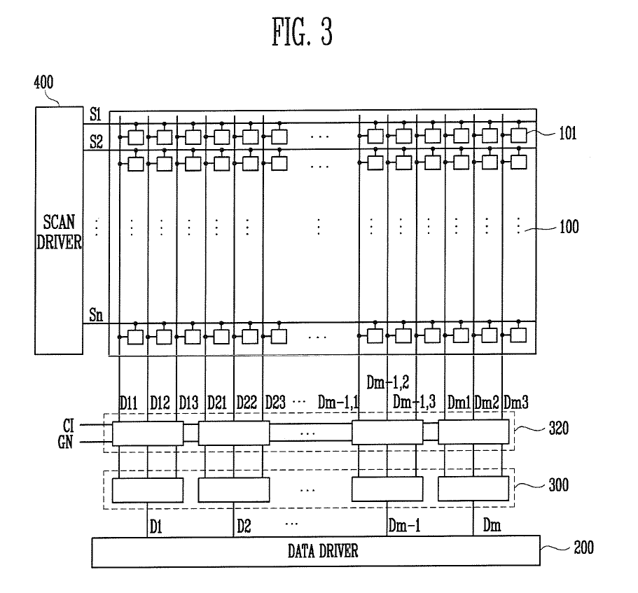

FIG. 2 is a schematic view showing an organic electroluminescence display device according to an aspect of the present invention. Referring to FIG. 2, the organic electroluminescence display device includes a pixel unit 100, a data driver 200, a MUX unit 300 and a scan driver 400.

The pixel unit 100 has a plurality of pixels 101 arranged therein and an organic light emitting diode (not shown) connected to each of the pixels 101. The pixel unit 100 has a plurality of scan lines (S1,S2, . . . Sn−1,Sn) formed in a horizontal direction and supplying a scan signal, and a plurality of data lines (D11, D12,D13, . . . Dm1,Dm2, Dm3) formed in a vertical direction and supplying a data signal. The pixel unit 100 displays an image by allowing the organic light emitting diode to emit the light according to the scan signal and the data signal.

The data driver 200 is a unit for applying the data signal to the pixel unit 100, and has a plurality of channels (D1, D2, . . . Dm−1, Dm) for outputting the data signal to each of the channels. A size of the data driver 200 may be reduced since red, green, and blue data are sequentially outputted in one channel thus lowering the number of channels of the data driver 200 when compared to the number of the data lines (D11, D12,D13, . . . Dm1,Dm2, Dm3) of the pixel unit 100. Also, the data driver 200 may reset the data lines (D11, D12,D13, . . . Dm1,Dm2, Dm3) by outputting the reset signal in each of the channels (D1, D2, . . . Dm−1, Dm).

The MUX unit 300 may be connected between the data lines (D11, D12,D13, . . . Dm1,Dm2, Dm3) and the channels (D1, D2, . . . Dm−1, Dm) to sequentially supply red, green and blue data signals, outputted through one channel, corresponding to the three data lines, and also the MUX unit 300 may supply the reset signal, outputted in the channels, to the three data lines so as to reset the data lines.

The scan driver 400 is a unit sequentially outputting a scan signal and connected to the scan lines (S1,S2, . . . Sn−1,Sn), and supplies the scan signal to a specific row of the pixel unit 100. The data signal inputted in the data driver 200 is applied to the specific row of the pixel unit 100 to which the scan signal is supplied to display an image, and one frame is completed if all rows are sequentially selected.

FIG. 3 is a schematic view showing an organic electroluminescence display device according to an aspect of the present invention. Referring to FIG. 3, the organic electroluminescence display device includes a pixel unit 100, a data driver 200, a MUX unit 300, a reset unit 320 and a scan driver 400.

The pixel unit 100 has a plurality of pixels 101 arranged therein and an organic light emitting diode (not shown) connected to each of the pixels 101. The pixel unit 100 has a plurality of scan lines (S1,S2, . . . Sn−1,Sn) formed in a horizontal direction and supplying a scan signal, and a plurality of data lines (D11, D12,D13, . . . Dm1,Dm2, Dm3) formed in a vertical direction and supplying a data signal. The pixel unit 100 displays an image by allowing the organic light emitting diode to emit the light according to the scan signal and the data signal.

The data driver 200 applies the data signal to the pixel unit 100, and has a plurality of channels (D1, D2, . . . Dm−1, Dm) for outputting the data signal to each of the channels. A size of the data driver 200 may be reduced since red, green, and blue data is sequentially outputted in one channel, thus lowering the channel number of the data driver 200 compared to the number of the data lines (D11, D12,D13, . . . Dm1,Dm2, Dm3) of the pixel unit 100.

The MUX unit 300 may be connected between the data lines (D11, D12,D13, . . . Dm1,Dm2, Dm3) and the channels (D1, D2, . . . Dm−1, Dm) and sequentially supplies red, green and blue data signals, outputted through one channel, to the corresponding three data lines so as to reduce the channel number of the data drivers 200.

The reset unit 320 is connected to an output terminal of the MUX unit 300 and includes a reset line for supplying a reset signal; and a reset control line controlling the reset unit. The reset unit 320 is reset by supplying the reset signal, supplied to the reset control line through the reset line, to the data lines (D11, D12,D13, . . . Dm1,Dm2, Dm3).

The scan driver 400 is a unit sequentially outputting a scan signal and connected to the scan lines (S1,S2, . . . Sn−1,Sn) and supplying the scan signal to a specific row of the pixel unit 100. The data signal inputted in the data driver 200 is applied to the specific row of the pixel unit 100 to which the scan signal is supplied to display an image, and one frame is completed if all rows are sequentially selected.

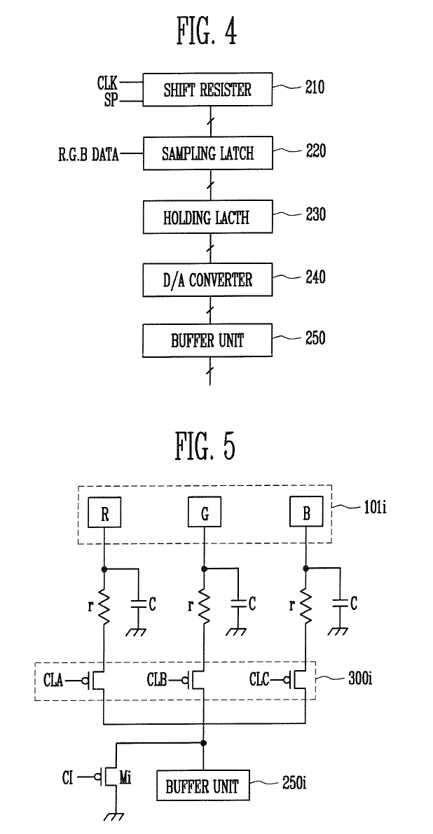

FIG. 4 is a schematic view showing a data driver used in the organic electroluminescence display device as shown in FIG. 2. Referring to FIG. 4, the data driver 200 includes a shift resistor 210, a sampling latch 220, a holding latch 230, a D/A converter 240 and a buffer unit 250.

The shift resistor 210 sequentially shifts a start pulse (SP) according to a clock signal (CLK) to generate a sampling signal, thereby applying the generated sampling signal to the sampling latch 220.

The sampling latch 220 receives the sampling signal outputted from the shift resistor 210, and then stores a digital data signal inputted in series from the outside according to the sampling signal.

The holding latch 230 receives the digital data signal; stored in the sampling latch 220, depending on a holding signal (DH) supplied from the outside, holds the received digital data signal during a first horizontal period, and then outputs the digital signal.

The D/A converter 240 receives the digital data signal and converts the received digital data signal to an analog data signal, and outputs a voltage corresponding to each of the grey levels.

The buffer unit 250 is a unit amplifying and outputting the analog data signal, and prevents the data signal from being distorted by a load of the data lines. An output terminal of the buffer unit 250 may be referred to as a channel, and the analog data signal is outputted to every channel.

FIG. 5 is a circuit view showing a connection relation between a data driver and a MUX unit in the organic electroluminescence display device as shown in FIG. 2. Referring to FIG. 5, pixels 101i represented by R, G and B; data lines connected to each of the pixels; a MUX unit 300i connected to the data lines; a buffer unit 250i of the data driver; and a reset transistor (Mi) connected to the buffer unit 250i are sequentially connected to each other. Additionally, “r” and “C” represent a line resistance and a parasitic capacitor of the data line, respectively.

The reset transistor (Mi) has a source connected to the data lines; a drain connected to the ground power source; and a gate connected to the reset signal line (Cl). Therefore, the reset transistor (Mi) may reset the voltage of the data lines through the voltage of the ground power source by carrying out a switching operation according to the reset signal line (Cl). Here, the source may be referred to as a first electrode, the drain may be referred to as a second electrode, and the gate may be referred to as a third electrode.

Referring to an operation of the reset transistor (Mi), a R data signal outputted from the buffer unit 250i is supplied to a R pixel through the MUX unit 300i, a G data signal is supplied to a G pixel through the MUX unit 300i, and a B data signal is supplied to a B pixel through the MUX unit 300i. Accordingly, the R data signal, the G data signal and the B data signal are stored in the data lines, respectively. Furthermore, if the buffer unit 250i is disconnected from the data lines, then the reset transistor (Mi) is in a turned-on state through the reset control signal, supplying the ground power source to the data lines. Accordingly, the data lines are reset by the ground power source. The ground power source uses a ground.

FIG. 6 is a circuit view showing a connection relation between a data driver and a MUX unit in the organic electroluminescence display device as shown in FIG. 3. Referring to FIG. 6, there is shown the connection relation of pixels 101i represented by R, G and B; data lines connected to each of the pixels; a reset unit 320i connected to the data lines; a MUX unit 300i connected to the data lines; a buffer unit 250i of the data driver; and reset transistors (Mr), (Mb) and (Mg) connected to the buffer unit 250i. Also, “r” and “C” represent a line resistance and a parasitic capacitor of the data line, respectively.

The reset unit 320i includes a first transistor (Mr) having a first electrode connected to the red data line, a second electrode connected to the ground power source (GND) and a gate connected to the reset control signal line (Cl); a second transistor (Mb) having a first electrode connected to the green data line, a second electrode connected to the ground power source (GND) and a gate connected to the reset control signal line (Cl); and a third transistor (Mg) having a first electrode connected to the blue data line, a second electrode connected to the ground power source (GND) and a gate connected to the reset control signal line (Cl).

Referring to an operation of the reset transistors (Mr), (Mb) and (Mg), a R data signal outputted from the buffer unit 250i is supplied to an R pixel through the MUX unit 300i, a G data signal is supplied to a G pixel through the MUX unit 300i, and a B data signal is supplied to a B pixel through the MUX unit 300i. Accordingly, the R data signal, the G data signal and the B data signal are stored in the data lines, respectively. And, if the first transistor (Mr), the second transistor (Mb) and the third transistor (Mg) are in a turned-on state by the reset control signal and the connection relation between the data line and the MUX unit 300i is in a turned-off state, then the ground power source is supplied to the data lines to reset the data lines through the ground power source. The reset signal uses a ground.

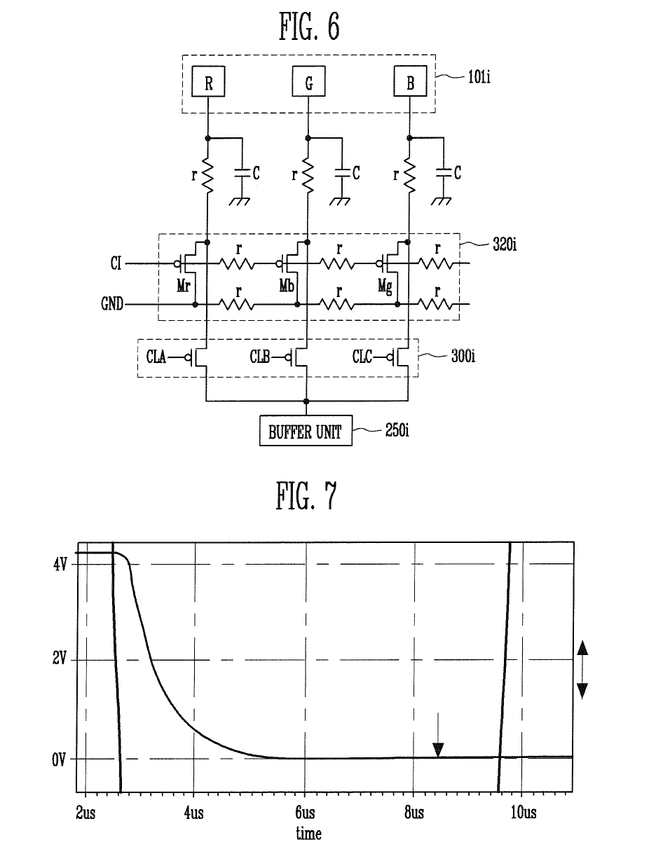

FIG. 7 is a diagram showing a voltage of a data line in the organic electroluminescence display device as shown in FIG. 2. Referring to FIG. 7, the horizontal axis represents a time, and the principal axis represents a voltage of the data line. If the reset signal is applied when a voltage of 4V is charged in the data lines, a voltage of the data signal approaches a voltage of 0V when a voltage of the data line drops for a time of 4 μs.

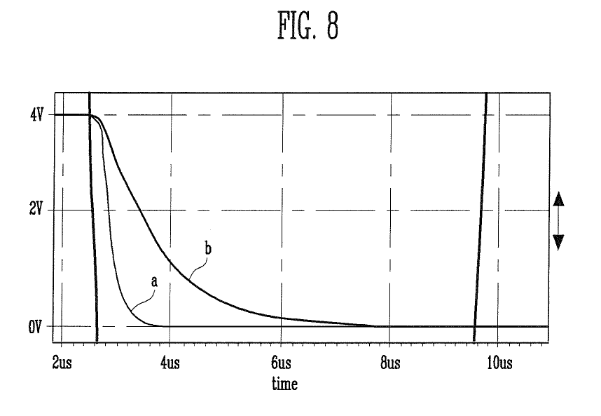

FIG. 8 is a diagram showing a voltage of a data line in the organic electroluminescence display device as shown in FIG. 3. Referring to FIG. 8, the horizontal axis represents a time, and the principal axis represents a voltage of a data line. And, “a” is a graph showing a voltage change of the data line arranged in a central region of the pixel unit, and “b” is a graph showing a voltage change of the data line arranged in an edge of the pixel unit.

Comparing “a” with “b”, it might seem that the data line arranged in a central region of the pixel unit is reset at a more rapid rate than the data line arranged in an edge of the pixel unit.

As described above, the organic electroluminescence display device and the driving method for the same according to aspects of the present invention may be useful in reducing a size of a data driver by connecting a plurality of data lines to one channel of the data driver through a MUX unit to reduce the number of the data lines, as well as to reduce a deviation of electric current flowing in pixels by resetting the data lines.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An organic electroluminescence display device comprising:
a pixel unit including a plurality of pixels defined by data lines and scan lines and displaying an image to correspond to a data signal and a scan signal;
a data driver generating the data signal and supplying the data signal to the pixel unit through a plurality of channels;
a MUX unit connected to the data lines and outputting the data signals from the data driver and selectively supplying the data signal to the data lines;
a scan driver generating a scan signal and supplying the generated scan signal to the pixel unit; and
a reset signal transmitting unit, supplying a reset control signal, connected to the channels of the data driver and providing the reset signal to the data lines through the MUX unit.

2. The organic electroluminescence display device according to claim 1, wherein the reset signal transmitting unit has a first electrode connected to one of the channels; a second electrode connected to a ground power source; and a gate to which the reset control signal is connected, and includes a reset transistor supplying the ground power source to the MUX unit according to the reset control signal.

3. The organic electroluminescence display device according to claim 1, wherein the data driver comprises:
a shift resistor generating a sampling signal;
a sampling latch sampling a digital data signal into the sampling signal;
a holding latch holding digital data, sampled from the sampling latch, for a certain period and then outputting the digital data;
a D/A converter converting the digital data signal to an analog data signal;
a buffer unit including the plurality of channels and outputting a voltage corresponding to the analog data signal in each of the channels; and
a reset transistor connected to each of the channels and switching a ground power source to supply the ground power source to the MUX unit.

4. The organic electroluminescence display device according to claim 1, wherein the channels are in a turned-off state when the reset control signal is supplied to the data lines through the reset signal transmitting unit.

5. An organic electroluminescence display device comprising:
a pixel unit including a plurality of pixels defined by data lines and scan lines and displaying an image to correspond to a data signal and a scan signal;
a data driver generating the data signal and supplying the data signal to the pixel unit through a plurality of channels;
a MUX unit connected to the data lines and outputting the data signal from the data driver to the data lines;
a reset unit connected to the data lines and supplying a ground power source; and
a scan driver generating the scan signal to supply the generated scan signal to the pixel unit.

6. The organic electroluminescence display device according to claim 5, wherein the reset unit comprises:
a first transistor having a first electrode connected to the data lines to which red data is supplied; a second electrode connected to the ground power source; and a gate connected to a control signal line;
a second transistor having a first electrode connected to the data lines to which green data is supplied; a second electrode connected to the ground power source; and a gate connected to the control signal line; and
a third transistor having a first electrode connected to the data lines to which blue data is supplied; a second electrode connected to the ground power source; and a gate connected to the control signal line.

7. The organic electroluminescence display device according to claim 5, wherein the data driver comprises:
a shift resistor generating a sampling signal;
a sampling latch sampling a digital data signal into the sampling signal;
a holding latch holding digital data, sampled from the sampling latch, for a certain period and then outputting the digital data;
a D/A converter converting the digital data signal to an analog data signal; and
a buffer unit including the plurality of channels and outputting a voltage corresponding to the analog data signal in each of the channels.

8. The organic electroluminescence display device according to claim 5, wherein the channels are in a turned-off state when a reset signal is supplied to the data lines through the reset unit.

9. A method of driving an organic electroluminescence display device that resets data lines using a reset signal, comprising:
generating a data signal and supplying the generated data signal to data lines; and
interrupting the data signal and supplying the reset signal to the data lines.

10. The method of driving an organic electroluminescence display device according to claim 9, wherein the reset signal uses a ground.

11. The method of driving an organic electroluminescence display device according to claim 9, wherein the generated data signal is supplied to one of three data lines of the pixel electrode.

12. An organic electroluminescence display device comprising:
a pixel unit including a plurality of pixels defined by data lines and scan lines and displaying an image according to a data signal and a scan signal;
a data driver generating the data signal and supplying the data signal to the pixel unit through a plurality of channels;
a MUX unit including a plurality of multiplexers, each multiplexer connected to three data lines and to one channel and outputting the data signal from the data driver to the three data lines; and
a scan driver generating a scan signal to the pixel unit,
and a reset signal transmitting unit connected to the channels,
wherein the reset signal transmitting unit resets the data lines by applying a reset power source to the data lines.

13. The organic electroluminescence display device according to claim 12, wherein the data driver comprises:
a shift resistor generating a sampling signal;
a sampling latch sampling a digital data signal into the sampling signal;
a holding latch holding digital data, sampled from the sampling latch, for a certain period and then outputting the digital data;
a D/A converter converting the digital data signal to an analog data signal; and
a buffer unit including the channels and outputting a voltage corresponding to the analog data signal to each of the channels.

14. The organic electroluminescent display device of claim 12, wherein each channel of the data driver applies the data signal to three data lines of the MUX unit

15. The organic electroluminescence display device according to claim 12, wherein the reset signal transmitting unit includes a reset transistor connected to the data lines.

16. The organic electroluminescence display device according to claim 15, wherein the reset transistor has a source connected to the data line, a drain connected to the reset power source and a gate connected to a reset signal line of the reset signal transmitting unit, wherein a voltage of the data line is reset through a voltage of the reset power source through a switching operation according to the reset signal line.

17. The organic electroluminescence display device according to claim 12, wherein the reset signal transmitting unit includes a plurality of reset transistors connected to the data lines.

18. The organic electroluminescence display device according to claim 12, wherein the three data lines include a red data line, a green data line and a blue data line.

19. The organic electroluminescence display device according to claim 12, wherein the reset signal transmitting unit includes a first transistor having a first electrode connected to the red data line, a second electrode connected to the reset power source and a gate connected to a reset control signal line of the reset signal transmitting unit; a second transistor having a first electrode connected to the green data line, a second electrode connected to the reset power source and a gate connected to the reset control signal line; and a third transistor having a first electrode connected to the blue data line, a second electrode connected to the reset power source and a gate connected to the reset control signal line.

20. The organic electroluminescence display device according to claim 12, wherein the reset power source is a ground power source.
